(19) United States
(12) Patent Application Publication
(10) Pub. No.: US 2011/0035696 A1
(43) Pub. Date: Feb. 10, 2011

(54) CHARACTER INPUT SYSTEM FOR LIMITED KEYBOARDS

(76) Inventors: Avi Elazari, Hod-HaSharon (IL); Eran Ovadia, Mevasseret Zion (IL); Eytan Alon, Hod-Hasharon (IL); Yossi Haran, Modiln (IL)

Correspondence Address: MARTIN D. MOYNIHAN d/b/a PRTSI, INC., P.O. BOX 16446, ARLINGTON, VA, 22215, US

(21) Appl. No.: 12/743,847

(22) PCT Filed: Nov. 20, 2008
(86) PCT No.: PCT/IL08/01522

§ 371 Date: Oct. 21, 2010

Related U.S. Application Data
(60) Provisional application No. 60/989,125, filed on Nov. 20, 2007.

(51) Int. Cl. G06F 3/048

(52) U.S. Cl. 715/773

(57) ABSTRACT

A character input system for a limited keyboard, in which a number of input keys in the keyboard is smaller than a number of characters in an input alphabet, the system comprising: a memory comprising a plurality of different mappings of said characters onto combinations of said keys; and a selector for allowing a user to select one of said mappings for character input. The different mappings are optimized for different users and different purposes, so that the user may select a mapping for simplicity of use, or one optimized for touch-typing, or for minimal key pressing or for minimal ambiguity or for other factors and combinations thereof.

### FIELD AND BACKGROUND OF THE INVENTION

The present invention, in some embodiments thereof, relates to a character input system for limited keyboards, and more particularly but not exclusively to a system where character assignment between the keys is optimized for the limitations of the keyboard.

The concept of optimizing characters for the limitations of the keyboard is as old as electronic communication itself. The Morse code, in which the alphanumeric characters were mapped onto different combinations of a dot and a dash, was not a case of simple mapping but rather the characters were allocated in such a way that the most frequent characters were given the shortest combinations. The aim was to minimize the total number of key presses for a message of any given number of words.

Text messaging, a feature that has become available in recent years with mobile phones, demands the ability to produce alphabetic characters from the numerical keyboard. Current mobile telephones have alphabetic characters assigned to the keys in groups so that several characters map to a key, and each character in succession at the key is obtained by a number of presses corresponding to its position in the succession. The characters are assigned in alphabetical order to ease the user's task in finding the key, thus the characters A, B and C are assigned to the 1 key, D, E and F to the 2 key and so on.

Such assignment in pure alphabetical order does not help to minimize key presses for any given message. Thus the most common character, E, requires two presses on the 3 key, whereas the extremely uncommon character J requires just a single press of the 5 key.

However assignments of keys in different orders on the keyboard, whether to minimize key strokes or for any other purpose, tend to generate consumer resistance since many members of the public simply want the most user friendly keyboard for the purposes of sending the occasional text message, meaning the most straightforward keyboard for the purpose of locating characters. Such a keyboard is precisely that described above in which characters are placed in simple alphabetical order.

### SUMMARY OF THE INVENTION

The present invention in some embodiments provides a selection of character mappings for a limited keyboard, so that the end user can choose between harder to learn mappings optimized for efficiency and easier to learn mappings based on simple alphabetical order. The heavy user of text messaging would select the efficient mapping schemes and take the trouble to learn a keyboard that would make their messaging more efficient. Other mobile telephone users can select the straightforward layout and not be inconvenienced in any way.

Embodiments also relate to ways in which optimized mappings of the characters onto different size keyboards may be produced.

According to an aspect of some embodiments of the present invention there is provided a character input system for a limited keyboard, in which a number of input keys in the keyboard is smaller than a number of characters in an input alphabet, the system comprising:

a memory comprising a plurality of different mappings of the characters onto combinations of the keys; and

a selector for allowing a user to select one of the mappings for character input.

In an embodiment, at least one of the mappings is made for ease of learning by a user.

In an embodiment, at least one of the mappings is made to minimize key presses for typing messages in a given language.

In an embodiment, at least one of the mappings is an optimization between ease of learning by a user and a minimization of key presses for typing messages in a given language.

In an embodiment, at least one of the mappings is made to minimize repeat key operations in a given language.

In an embodiment, at least one of the mappings is made to minimize ambiguities due to similar key sequences being shared by different words.

In an embodiment, the selector is configured to allow a user to select a mapping on the basis of a preference between ease of learning, and minimization of key presses.

In an embodiment, the mapping comprises mapping of characters to combinations of the keys.

In an embodiment, at least some of the combinations are key sequences.

In an embodiment, more frequent characters in a given language are assigned to shorter combinations and less frequent characters are assigned to longer combinations.

In an embodiment, characters are assigned to combinations in the order of an alphabet of the characters.

In an embodiment, more than one character is assigned to a single combination, the user being enabled to scroll between characters sharing the same combination.

In an embodiment, the language comprises an on-line community jargon, and the optimization is based on a statistical analysis of character usage within the community.

An embodiment may involve assigning audible tones to different keys, so that key combinations provide distinctive chords.

An embodiment may involve displaying a selected mapping on a user screen as groups of characters, each group associated with a matrix of the keys, wherein for each matrix different keys are shown as to be activated.

In an embodiment, the mapping comprises sequential combinations of keys and each matrix shows in differentiated form, those keys to be activated earlier and those keys to be activated later in the sequential combination.

In an embodiment, the mapping to minimize key presses is constructed from a mapping having a relatively large standard deviation of the average number of presses per character, thereby to allow mapping of frequently used characters to shorter numbers of presses and less frequently used characters to longer presses.

According to a second aspect of the present invention there is provided a character mapping method for a limited keyboard, in which a number of input keys in the keyboard is smaller than a number of characters in an input alphabet, the method comprising:

mapping the characters in at least two different ways to keys on the keyboard, to provide at least two different keyboard mappings; and

allowing a user to select one of the keyboard mappings for character input at the limited keyboard.

In an embodiment, one of the mappings is provided by mapping the characters to combinations of the keys in an alphabetic order for ease of learning.

In an embodiment, one of the mappings is provided by:

statistically analyzing use of the characters to determine a frequency for respective characters;

providing a series of key combinations for the characters, the series having an average number of key combinations and a predetermined standard deviation from the average; and

assigning relatively frequently used characters to combinations having relatively low numbers of key presses and relatively infrequently used characters to combinations having a relatively high number of key presses, thereby to provide a mapping which minimizes key presses.

In an embodiment, the statistically analyzing is carried out for character usage by a defined on-line community, or wherein at least one of the mappings is made to minimize repeat key operations in a given language.

An embodiment may comprise adding a weighting to each language based on user evaluation of a difficulty of typing respective key combinations multiplied by a frequency of occurrence of the combinations and on a difficulty in changing between different key combinations multiplied by a frequency of occurrence of the changes.

In an embodiment, at least one of the mappings is made to minimize ambiguities due to similar key sequences being shared by different words.

According to a third aspect of the invention there is provided a method of providing a keyboard based on mapping a first number of characters onto a keyboard having a second number of keys, wherein the first number is larger than the second number, the method comprising:

analyzing a language usage database for usage statistics;

applying the characters in at least two ways onto the keyboard to form at least two mappings;

providing a score to the mapping based on the usage statistics applied to the keyboard; and

selecting between the languages for use based on the score.

In an embodiment, the usage statistics applied to the keyboard comprise at least one member of the group consisting of: character frequency, number of key presses needed to generate a word, number of words in the database having identical key press sequences, and number of words requiring identical key presses in succession.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram illustrating a limited keyboard device according to a first preferred embodiment of the present invention;

FIG. 2 is a simplified diagram illustrating a screen layout of a device according to a preferred embodiment of the present invention using a series of four soft keys to which combinations of characters are mapped;

FIG. 3 is a simplified diagram showing the screen layout of FIG. 2 in which the same characters are mapped in a different way onto the same four input keyboard;

FIG. 4 is a simplified diagram showing another screen layout according to an embodiment of the present invention in which the characters of the Latin alphabet are mapped onto a seven key input;

FIG. 5 is a simplified diagram showing the screen layout of FIG. 4 with an alternative character mapping;

FIG. 6 is a simplified flow chart illustrating a process of mapping characters onto a keyboard taking various statistical issues into account;

FIG. 7 is a graph that shows how an input cost can be constructed from a user supplied fingering score combined with a character occurrence probability, for the AB13 mapping of table 1;

FIG. 8 is a graph which shows how an input cost can be constructed from a user supplied fingering score combined with a character occurrence probability, for the R13 mapping of table 2;

FIG. 9 is a simplified flow chart showing how segments input at the keyboard are made up into characters and echoed to the screen;

FIG. 10 is a simplified diagram illustrating a series of devices using mapped keyboards according to embodiments of the present invention;

FIG. 11 is a simplified diagram illustrating additional devices using mapped keyboards according to embodiments of the present invention;

FIG. 12 illustrates a mapping of Latin characters to a four input keyboard using segment repeats and a basic alphabetic order modified to reduce key presses according to an embodiment of the present invention;

FIG. 13 illustrates a mapping of Latin characters to a three input keyboard using segment repeats and strict alphabetic order to provide a user friendly mapping;

FIG. 14 illustrates a mapping of Latin characters to a four input keyboard where each character is given a unique combination of segments, the successive segments assigned to the same character being different, according to an embodiment of the present invention;

FIG. 15 is a simplified diagram showing different options for system feedback of a device according to an embodiment of the present invention including visual, spoken and musical;

FIG. 16 is a simplified diagram showing how user ratings of different segments can be used to generate a cost function for a character mapping according to an embodiment of the present invention; and

FIG. 17 is a simplified block diagram illustrating a device according to an embodiment of the present invention which uses a limited keyboard and characters mapped to the keyboard in accordance with embodiments of the present invention.

### DESCRIPTION OF EMBODIMENTS OF THE INVENTION

The present invention, in some embodiments thereof, relates to a character input system for limited keyboards, and more particularly but not exclusively to a system where character assignment between the keys is optimized for the limitations of the keyboard.

A character input system for a limited keyboard is provided, in which a number of input keys in the keyboard is smaller than a number of characters in an input alphabet. A memory comprises two or more different mappings of the characters onto combinations of the keys; and a selector allows a user to select one of the mappings for character input. The different mappings are optimized for different users and different purposes, so that the user may select a mapping for simplicity of use, or one optimized for touch-typing, or for minimal key pressing or for minimal ambiguity or for other factors and combinations thereof, or for a different language or jargon such as an on-line community jargon.

More particularly, a device with a minimal keyboard, such as a mobile telephone, is provided with alternative character-to-keyboard mappings, some optimized for ease of use and others optimized for efficient typing. The user is able to select the keyboard most efficient for his purposes.

The mappings may be of groups of characters to individual keys, or of individual characters to key chords, or individual characters to key sequences, or of groups of characters to chords or sequences.

Keys and chords may be associated with audible tones or with electronic text to speech to assist with touch-typing (blind typing).

Embodiments further relate to different ways in which characters may be mapped to different sizes of keyboards for the different purposes referred to hereinabove.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

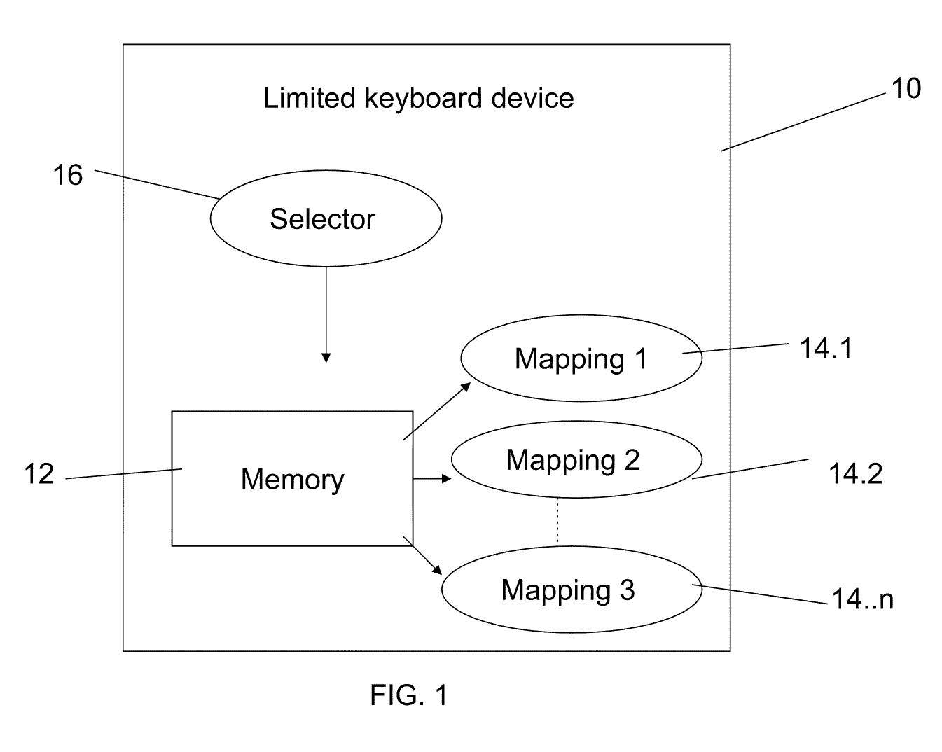

Referring now to the drawings, FIG. 1 illustrates a character input system for a limited keyboard, in which a number of input keys in the keyboard is smaller than a number of characters in an input alphabet. Such a situation is typical of mobile telephones and like devices, yet such devices are used more and more frequently to send text messages such as short messaging service (SMS) messages. Today the alphabetic characters are simply assigned to single numerical keys in alphabetic order so that each character assigned to the same key is obtained by a different number of presses of the same key. Such a system, while simple even for first-time users to understand, is not helpful for efficient typing, the number of key presses per message is relatively high, and the system does not lend itself to touch-typing.

FIG. 1 shows a limited keyboard device 10 having a memory 12 which contains several different mappings, 14.1, 14.2 . . . 14.n of the characters onto combinations of its keys. A selector 16 allows a user to select one of the mappings for character input in accordance with his or her preferences. That is to say the different mappings are made with different aims in mind, as will be explained in greater detail below, and the user is able to select the mapping most appropriate to his or her needs.

Thus one of the mappings may be made to be user friendly, allowing ease of use by the unfamiliar user, for example by providing the characters in a known order, such as alphabetic order, as with the naïve mapping widely in use today.

One of the mappings may be made to minimize key presses for typing messages in a given language. Thus frequent characters may be assigned a single key stroke or a very straightforward chord or sequence of strokes, and less frequent characters may be provided with more complex chords or longer sequences.

One factor that may be taken into account is avoidance of ambiguity. If different characters share the same key combination then such characters are likely to be mistakenly used in place of each other. A mapping can be made using statistical analysis to minimize the cases where two or more real words can be typed using the same key combination. Such a mapping would be ideal for touch-typing or blind typing where the user may not look at the word he has typed.

Again, one of the mappings may be a compromise between the above requirements, an optimization between ease of learning by a user—user friendliness, and a minimization of key presses for typing messages in a given language, or between the above and ambiguity.

The selector 16 may then offer the user the choice of the different mappings, and may indicate the differences so that the user can make the most appropriate choice.

Characters may be mapped to combinations of keys, or chords. Alternatively or in addition, some of the combinations may be key sequences.

In the efficient mappings, more frequent characters in a given language are assigned to shorter or simpler combinations and less frequent characters are assigned to longer or more complex combinations.

In the user-friendly mappings, characters are assigned to combinations in the order of an alphabet or the like, so that the characters can easily be found.

In some mappings, more than one character may be assigned to a single combination, the user being enabled to scroll between characters sharing the same combination.

The characters may be optimized for character frequency as per a dictionary of the particular language. However text messaging has its own jargon and its own peculiarities of usage. For example in English text messaging the letter “u” replaces the word “you” and acquires a frequency which is higher than its frequency in the standard language. Contractions of words are regularly used. Thus optimization for the standard language is not ideal for many users, and in one embodiment character mapping is provided by statistical analysis of actual usage of an on-line community such as teenage text messaging users and their jargon. The selector 16 may then offer such mappings as main or alternative keyboards, a mapping for standard English usage, and a mapping for proficient texters.

An embodiment may further include assigning audible tones to respective keys or combinations, especially to assist with blind or touch typing, as will be explained in greater detail below.

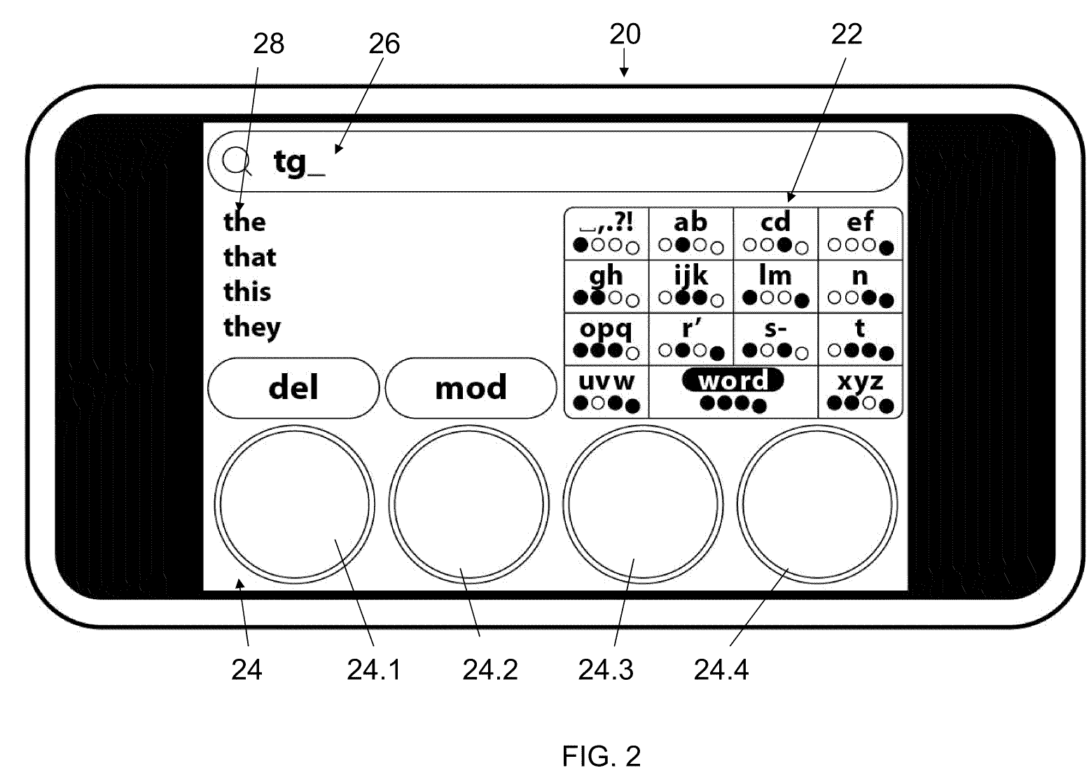

Reference is now made to FIGS. 2-5 which illustrate four different exemplary keyboard mappings. In each case the selected mapping is displayed on the user screen as groups of characters, and each group is associated with a matrix of the keys. In each matrix different keys are shown as activated to give that group of characters.

In FIG. 2, a screen display 20 is shown comprising a character mapping region 22, a soft key region 24 having four soft keys or buttons 24.1 . . . 24.4, an input box 26 and a suggestion region 28 for suggesting completed words based on the current key entry. In the case of FIG. 2 the entire Latin alphabetic character set is mapped onto different combinations of four buttons. The order of the characters is alphabetical for ease of use, but the most common characters either are first in their group, thus e, a, o, r, i, s, or are in groups on their own, thus t and n. One group is reserved for selecting a word from the suggestion region.

As will be seen the character combination “tg” has been typed in. There is no word in the dictionary having the combination “tg”, but g shares a chord with h, so the suggestion region 28 provides suggestions based on “th”.

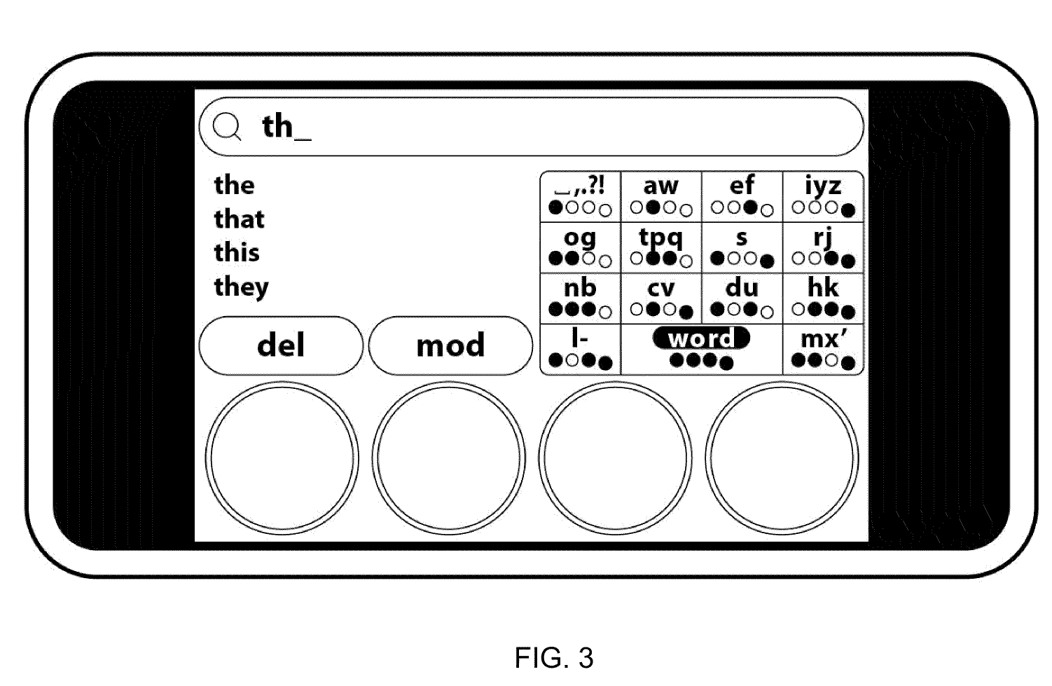

FIG. 3 is similar to FIG. 2 in showing a mapping of the Latin alphabet to four soft keys. However here the characters are no longer in alphabetical order, as the mapping is optimized for typing efficiency—all the most common letters come first in their respective groups. The mapping requires learning and is thus not easy to use, but once learnt provides for more efficient text messaging.

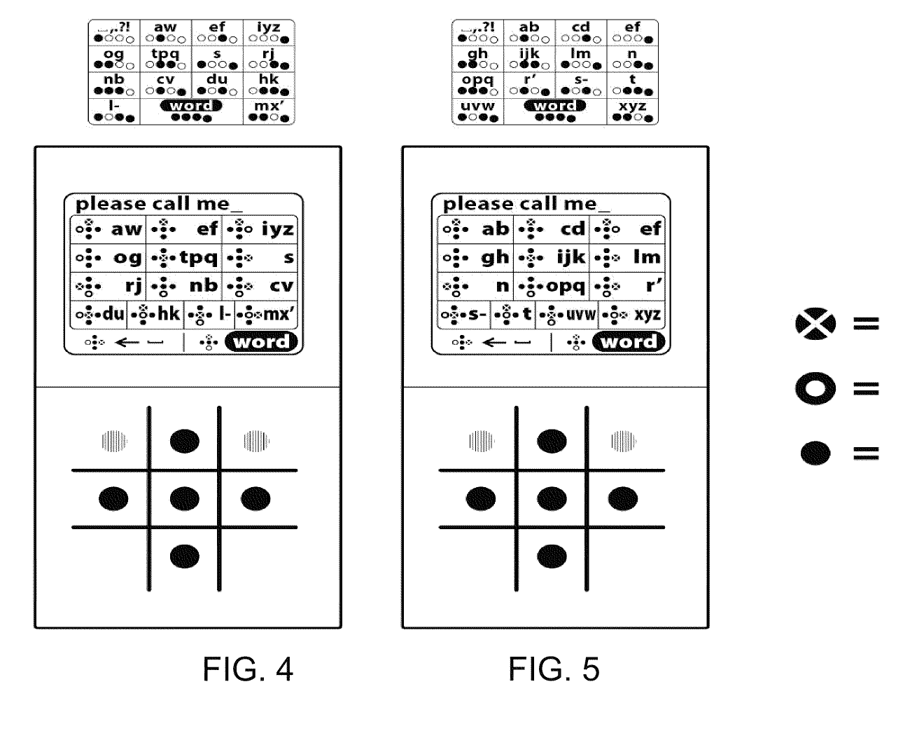

Reference is now made to FIGS. 4 and 5, in which the Latin alphabet is mapped onto a combination of seven keys. FIG. 5 shows the user friendly version in which the characters are mapped in alphabetical order, and FIG. 4 shows a version in which the characters are mapped in an optimized order. The seven keys may be pressed in sequence, with the upper row outermost keys, shaded in lighter grey, pressed after the other keys. That is to say the mapping may include sequential combinations of keys. Each matrix shows, in differentiated form, those keys to be activated earlier and those keys to be activated later in the particular sequential combination.

In an embodiment a mapping to minimize key presses is constructed from a mapping having a relatively large standard deviation of the average number of presses per character. That is to say some characters could be obtained from a single key press, and others from say four key presses. Given such a large range about the average it is possible to allow mapping of frequently used characters to shorter numbers of presses and less frequently used characters to longer presses.

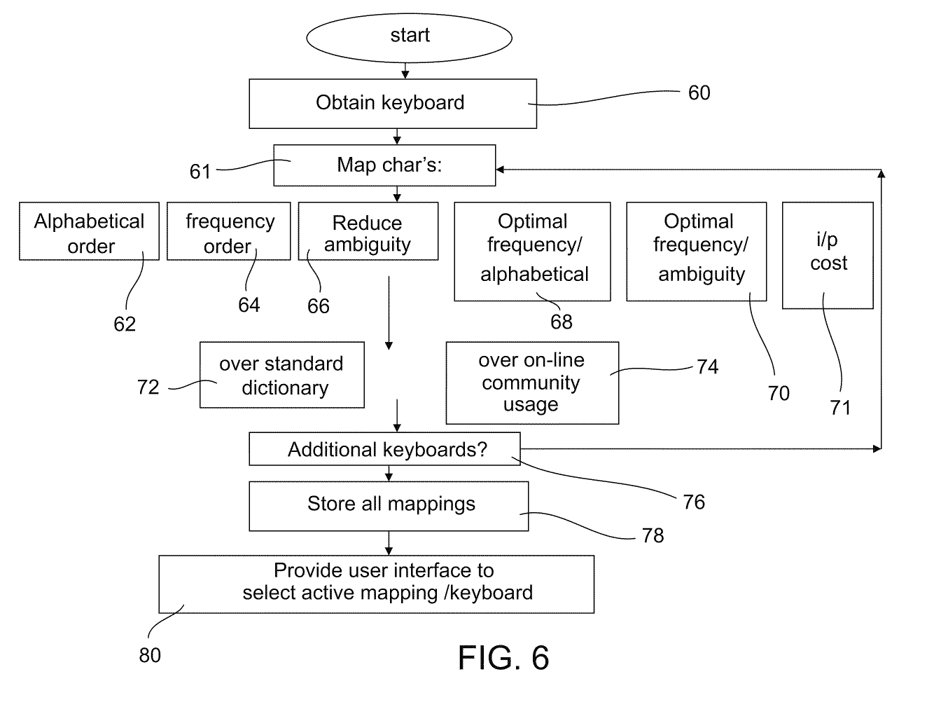

Reference is now made to FIG. 6 which illustrates a character mapping method for a limited keyboard. A limited keyboard is a keyboard in which a number of input keys in the keyboard is smaller than a number of characters in an input alphabet. As mentioned above this is usually the case with the numerical keypad in a mobile telephone but the issue is also applicable to soft touch keys which can be provided on screen. The method consists of mapping the characters in at least two different ways to keys on the keyboard, to provide at least two different keyboard mappings; and then allowing a user to select one of the keyboard mappings for character input at the limited keyboard.

In the case of a hard keyboard such as the numeric keypad on a mobile telephone the number of keys and the layout is already known. However in other cases a soft keypad of on-screen touch keys can be provided in customized manner.

The keyboard layout is obtained 60. Characters are then mapped to the keys and combinations of keys—box 61, according to different criteria. The mapping criteria may include ease of use—say by using alphabetical order 62. Alternatively, character usage frequency—to minimize key presses per word, 64, may be used. A further optimization is to reduce character ambiguity between key presses 66. Optimizations between any combinations of the above may also be used, thus box 68 shows that an optimization between alphabetical order and frequency usage may be made by retaining alphabetical order but assigning high frequency characters as first characters in a group or in groups on their own, and assigning lower frequency characters in larger groups or towards the end of groups. Box 70 shows an optimization between frequency and ambiguity.

Box 71 shows a cost function. The cost function is based on user assessment of the different key combinations, the segments and the string combining the segments, needed to obtain the character, in short the ease of learning and typing the character. The issue is discussed in greater detail hereinbelow.

The character frequency and character ambiguity are compiled statistically, either from a dictionary or from large samples of text. Different dictionaries or samples may be used for different mappings. Thus a standard language dictionary could be used for a certain kind of user, as shown in box 72. Alternatively or additionally, as shown in box 74, either a dictionary or samples from a particular on-line community may be used, so that different kinds of user have their own optimized keyboard.

Additional mappings may be generated based on different dictionaries or samples. In addition, the process may be repeated for different keyboard layouts, as indicated by box 76.

Thus one set of mappings may be provided for four keys and another set for five keys, and yet another set for the full numerical keyboard.

Finally the various layouts are stored, say in the ROM of the final product, stage 78, and the user is provided 80 with an interface, say during device setup, where he is able to select his preferred keyboard and mapping.

The user interface may allow the user to select his keyboard size as well as the mapping of characters onto the keyboard.

In the following, the process of mapping optimization is considered in greater detail and illustrated by an example in which five mappings are compared with reference mappings.

Initially, keyboard mappings of two types are constructed:
a. Optimized ordered: all characters are mapped to keys in alphabetical order, but the number of characters per key varies. In certain cases one or two order changes may be allowed.
b. Randomly optimized: no order of any kind exists.

2. The keyboard mappings above are compared to the following mappings:
a. Naïve ordered: characters in alphabetical order, either 2 or 3 letters per key for n>8 or 3 or 4 letters per key for n=8,7.
   Those include
      i. the standard SMS mapping to eight keys of the numerical keyboard,
      ii. the language as defined in U.S. Pat. No. 6,307,549 Volovitz,
      iii. the random language from U.S. Pat. No. 6,307,549 to Tegic.

3. Considerations for optimization:
a. No. of false rejections: given a database of 5,000 most frequently used words. A database representing 87% of all words was used as the source and then a statistical analysis was used to determine the percentage of words, normalized to the usage frequency of the given word, that may be overridden by another, more frequently used word, if a word prediction mechanism is applied.
   Such a prediction indicates those cases where a touch typist would have to stop, look and change the automatic selection.
b. The number of false rejections in shallow language: that is, given a database of 2,384 most frequently used words, that is all words used more than 0.0045% of the time, which is 77.4% of overall word use, what is the percentage of words, normalized to the individual word's usage frequency, that will be overridden by another, more frequently used word, if a word prediction mechanism is applied.
   This would supply an indication of where a touch typist would have to stop, look and change the automatic selection, if writing SMS, which generally uses shallow language.
c. % ambiguities: Ambiguities are those cases where the full word must be typed out before an unambiguous prediction could be made of the outcome. The ambiguity was initially calculated from a database of the 5,000 most frequently used words.
   This would supply an indication of where the touch typist would have to stop and pay attention to the list of potential words when using the word prediction mechanism
d. Extra keypresses or hits per word: A significant statistic is the number of keypresses needed per word in each language. Although the average number of keypresses per character cannot be changed for a given size keypad the number of presses per word can be changed by giving frequent characters short combinations and infrequent characters long combinations. The comparison was between the number of presses per word, normalized for usage frequency of the word, to normalized number of letters per word (3.63 average letters in a word, normalized for usage frequency).
   This statistic provides a measure of the number of keypresses that the user has to make in normal usage. For example in standard SMS mode a letter such as B requires two presses, a letter such as C requires three presses.
e. Repeated keys: This is the number of cases that two consecutive letters in a word use the same key, normalized for word usage frequency.
   in normal usage, the typist has to wait until a system time out when anticipating additional hits for the first letter, before he can start typing a new letter. This is annoying and wastes time.

4 Score:
a. Each of the above considerations allocates value to every language that is considered. All values are normalized to provide a comparable score and the SMS mapping, is used as a baseline by getting 100 points for each item. The repeated key score was squared to maintain score values distribution in correlation to other scores, to avoid distortions.
b. All five scores are unified by allocation of different weights to each one of them

TABLE 1
Comparison of optimized ordered languages to a reference language:
(Reference languages in Italics)

| | | | | | false | | |
|---|---|---|---|---|---|---|---|
| | | | | | rejection, | | |
| Number | Total | extra | Repeated | false | shallow | | |
| of keys | score | hits | keys | rejections | language | Ambig.s | Language |
| Ab7 | 109.9 | 86.5 | 158.1 | 113 | 110.6 | 83.3 | abcd, efgh, ijkl, mnopq, rs′-, |
| | | | | | | | tuv, wxyz |
| Sms | 100 | 100 | 100 | 100 | 100 | 100 | abc, def, ghi, jkl, mno′, pqrs, |
| (Naïve)8 | | | | | | | tuv-, wxyz |
| ab8 | 85.9 | 64.1 | 118.5 | 90.2 | 90.5 | 70.7 | abcd, efgh, ijk, lm, nopq, rs′-, |
| | | | | | | | tuv, wxyz |
| ab9 | 76.0 | 63.4 | 111.7 | 70.6 | 71.1 | 58 | abcd, efgh, ijk, lm, nop, qr, s′-, |
| | | | | | | | tuv, wxyz |
| ab10 | 44.4 | 51.6 | 45.6 | 45.4 | 43.2 | 36.3 | abcd, ef, gh, ijk, lm′, no, pqr, s-, |
| | | | | | | | tuv, wxyz |
| ab11 | 33.7 | 40.1 | 30.8 | 33.1 | 31.6 | 31.7 | ab, cd, ef, gh, ijk, lm′, no, pqr, s-, |
| | | | | | | | tuv, wxyz |
| ab12 | 29.9 | 40.1 | 29.2 | 24 | 21.2 | 27.7 | ab, cd, ef, gh, ij, kl, m′, no, pqr, s-, |
| | | | | | | | tuv, wxyz |
| ab13 | 15.8 | 23.5 | 11.1 | 18.3 | 17 | 10.8 | ab, cd, ef, gh, ijk, lm, n, opq, r′, s-, |
| | | | | | | | t, uvw, xyz |
| Weights | | 0.25 | 0.25 | 0.125 | 0.125 | 0.25 | |

TABLE 2
Comparison of optimized random languages to two reference languages
(Reference languages in Italics)

| | | | | | false | | |
|---|---|---|---|---|---|---|---|
| | | | | | rejection, | | |
| | Total | extra | Repeated | false | shallow | | |
| | score | hits | keys | rejections | language | Ambigs. | Language |
| r7 | 56.2 | 53.6 | 77.2 | 60.1 | 50.6 | 38.5 | isg, rpmq, adh-, nubkz, olcx, |
| | | | | | | | efwj, tyv′ |
| Sms | 100.0 | 100 | 100 | 100 | 100 | 100 | abc, def, ghi, jkl, mno′, pqrs, |
| (Naïve)8 | | | | | | | tuv-, wxyz |
| r8 | 36.4 | 40.8 | 48 | 37.2 | 29.9 | 23.4 | isk, r isk, rmvq, dhx, nub, acy, |
| | | | | | | | olgz, efwj, tp-′ |
| Tegic 9 | 26.0 | 31.9 | 29.6 | 29.1 | 21.8 | 17.1 | igj, rmvq, dhz, sub, acy, olkx, |
| | | | | | | | ef, nw, tp′- |
| r9 | 24.0 | 32.4 | 34.1 | 21.6 | 13.1 | 12.1 | sv′, amgz, dhx, tub, icy, olkq, |
| | | | | | | | efj, nw-, rp |
| r10 | 19.3 | 25.2 | 32.4 | 12.6 | 6.3 | 10.2 | tu, rp, sv′, dfx, nbz, olq, ew-, |
| | | | | | | | img, acy, hkj |
| r11 | 13.6 | 21.3 | 18.1 | 9.5 | 5.4 | 7.4 | sv, r′, tpq, dfx, nb, ic, ol, ew-, |
| | | | | | | | umg, ayz, hkj |
| r12 | 9.1 | 16.3 | 11.3 | 7.2 | 4 | 3.1 | iyz, aw, tpq, rj, lc, og, dx′, um, ef, |
| | | | | | | | sv, nb-, hk |
| r13 | 7.6 | 13.9 | 10.5 | 4.6 | 2.1 | 2.5 | iyz, aw, tpq, rj, cv, og, mx′, du, ef, |
| | | | | | | | s, l-, nb, hk |
| Weights | | 0.25 | 0.25 | 0.125 | 0.125 | 0.25 | |

### Fingering Optimization

The usage of languages for blind writing and different combinations of fingers per each key, as well as needs to memorize and present the language graphically require optimization of the allocation to fingers.
1. Considerations for finger allocation:
   a. Different finger settings have different levels of usage convenience. In the example each finger setting was allocated a score, and the score was obtained by user groups and interviews.
   b. In order to present the language in a visual way so that the user obtains orientation in the table and is able to memorize the language, fingering may be ordered according to simple logic
   c. Letters may be ordered with some association with alphabetic orders, to SMS keys, or by unifying principle as vowels.
2. The attached example includes fingering for optimized ordered and random mappings for 7 and 13 keys. As can be seen both 13 key mappings obtain high scores: 978 out of a maximum possible score of 1020 for the ordered mapping and 1021, out of maximum possible score of 1040 for the random language. The scores imply that optimized fingering combines learning and orientation considerations, with very little compromises on optimal usage and convenience.

TABLE 3
Fingering score - convenience and ease of use scores
given to fingering postions in a four key keyboard:

| | Fingering |
|---|---|
| | Score |
| Xooo | 11.1 |
| oXoo | 10.2 |
| XXoo | 10.0 |
| XXXo | 9.5 |
| ooXo | 8.8 |
| XXXX | 8.5 |
| oXXo | 6.8 |
| XoXo | 6.6 |
| oooX | 6.2 |
| oXXX | 5.8 |
| XooX | 5.0 |
| ooXX | 4.1 |
| XoXX | 4.0 |
| XXoX | 1.7 |
| oXoX | 1.7 |

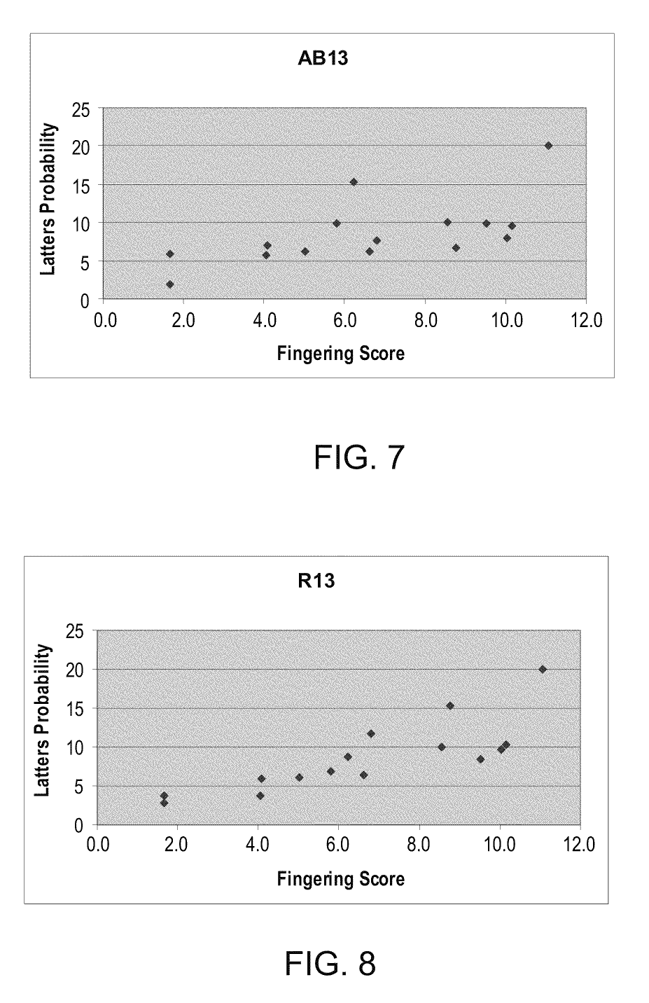

FIGS. 7 and 8 show the fingering scores above combined with character probabilities to provide overall scores to the AB13 keyboard mapping of Table 1 and the R13 keyboard mapping of Table 2.

### Chords

In an embodiment each key or finger position is provided with a musical note. This allows the chords (multi-key combinations) to be distinguished as musical chords to provide audible cues as to correct typing.

The example used the following in a four key system:

C (do) E (mi) G(sol) B flat (si flat)

In addition, modulations thereof may also be used. In such a setting all keys have different intervals, except for E-G compared to G-Bb.

### Sample Mappings

Sample mappings for seven keys and fifteen keys are given below. A matrix of the key positions is given first, followed by the mapping thereto of alphabetical characters.

TABLE 4
Sample mapping of alphabet characters to a seven key keyboard.
7 Keys

| | | |
|---|---|---|
| Xoo | oXo | ooX |
| XXo | XoX | oXX |
| | XXX | |

AB7

| | | |
|---|---|---|
| Abcd | efgh | ijkl |
| mnopq | rs′- | tuv |
| | wxyz | |

R7

| | | |
|---|---|---|
| Adh- | efwj | isg |
| nubkz | olcx | rpmq |
| | tyv′ | |

TABLE 5
Sample mapping of a 15 key keyboard to alphabetic characters.
15 keys

| | | | |
|---|---|---|---|
| Xooo | oXoo | ooXo | oooX |
| XXoo | oXXo | XooX | ooXX |
| XXXo | oXoX | XoXo | oXXX |

| | | |
|---|---|---|
| XoXX | XXXX | XXoX |

R13

| | | | |
|---|---|---|---|
| Space | aw | ef | iyz |
| og | tpq | s | rj |
| nb | cv | du | hk |
| | l- | word | mx′ |

AB10

| | | | |
|---|---|---|---|
| _,.?! | abcd 0 | ef 1 | gh 2 |
| Oooo | oOoo | ooOo | oooO |
| ijk 3 | lm′ 4 | no 5 | pqr 6 |
| OOoo | oOOo | OoOo | ooOO |
| s-7 | tuv 8 | word | wxyz 9 |
| OOOo | OOOO | OoOO | oOOO |

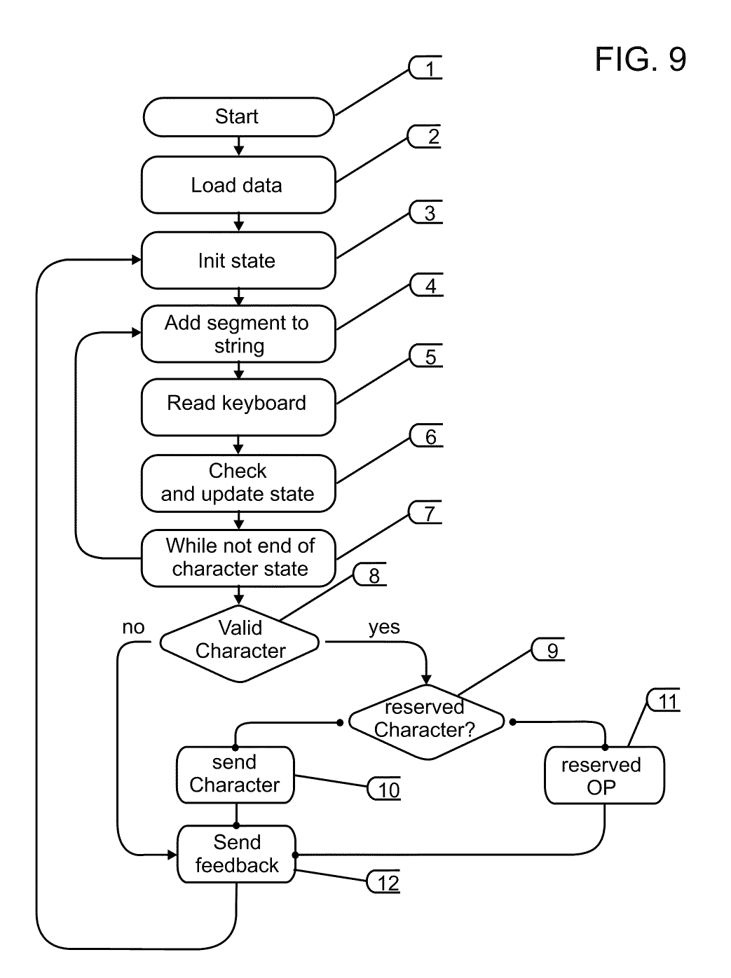

Reference is made briefly to FIG. 9 which shows how data is read from the keyboard and echoed onto the screen. The input character is read and added to the current string. If the character is a valid character then the character is sent to the keyboard. If the string calls for feedback then the string is sent to the operating system or active program as appropriate. If the character is a reserved character then the corresponding reserved operation is carried out.

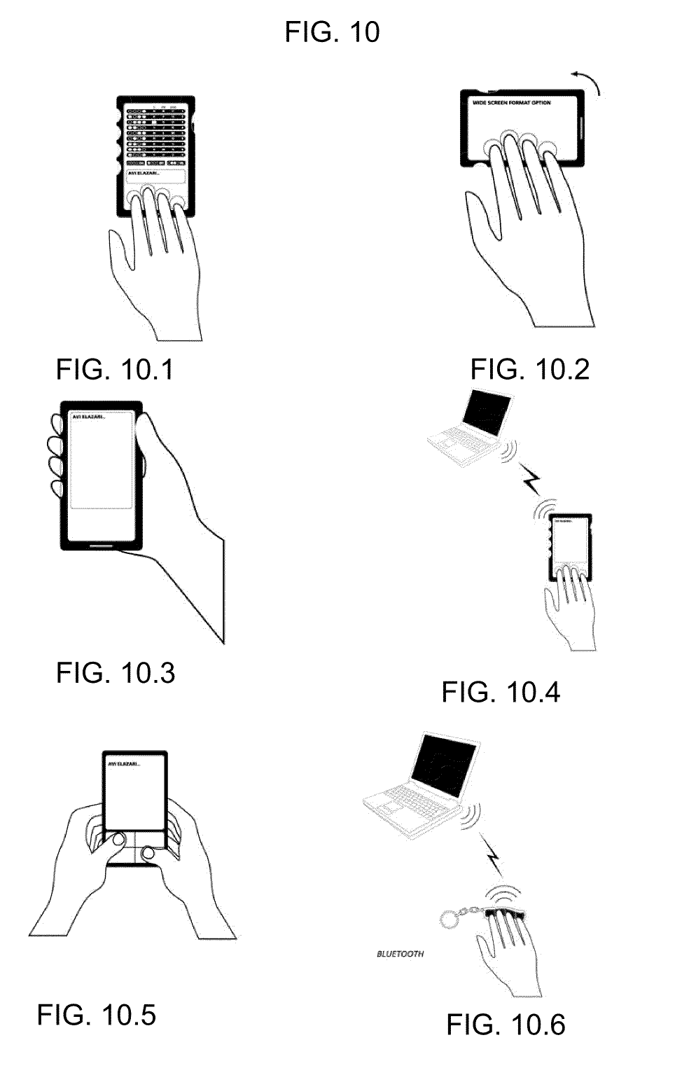

Reference is now made to FIG. 10, which shows a series of embodiments of devices using character mapped keyboards. Firstly a device using a character mapped four touch key soft keyboard is shown in FIG. 10.1. Note that the keys are offset from a straight line for improved comfort of the fingers. A four key character mapped keyboard in a horizontally positioned screen is shown in FIG. 10.2, again with the same offsetting of the keys for finger comfort. A system based on the hardware numerical keypad of a standard mobile device is shown in FIG. 10.3. A mobile device with a character mapped touch screen provides an input device for a separate host computer in FIG. 10.4. FIG. 10.5 shows a device in which a four key touch screen is operated by two thumbs. FIG. 10.6 shows a small device with a four key input which connects to other devices via a Bluetooth™ interface.

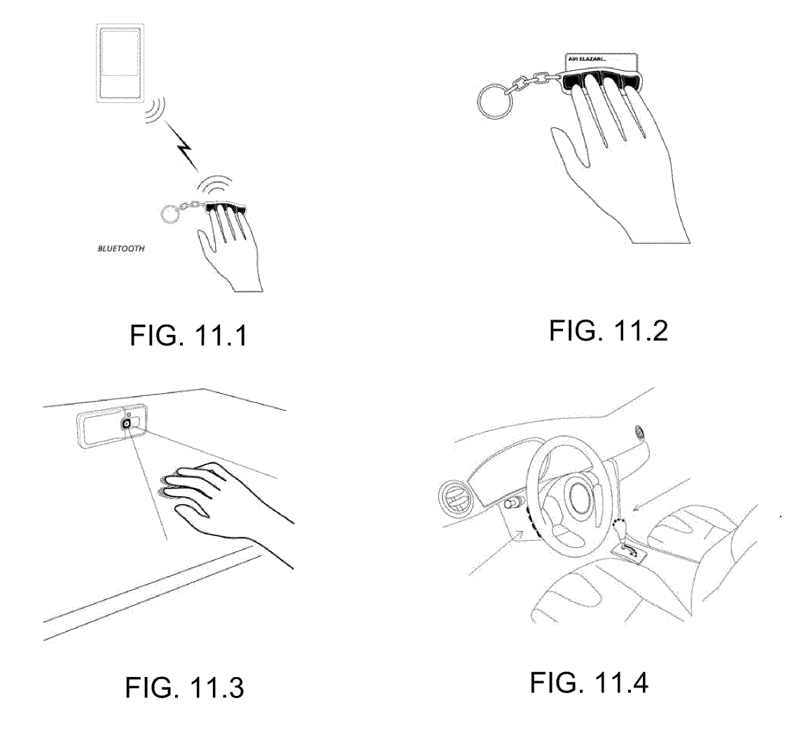

Reference is now made to FIG. 11, which shows additional applications for devices with limited keyboards and mapped characters. FIG. 11.1 illustrates a small device with a four key input which transmits to a mobile device via a Bluetooth™ interface or the like.

FIG. 11.2 shows a small device with a four key input and wireless, display and memory facilities, attached to a keyring. The device accepts input and sendsit on when convenient to a host computer. FIG. 11.3 illustrates a mobile phone in which the cell phone camera tracks finger movements to provide virtual soft keys.

A system in which soft keys for limited character input are placed on a peripheral device such as a joystick or steering wheel is shown in FIG. 11.4.

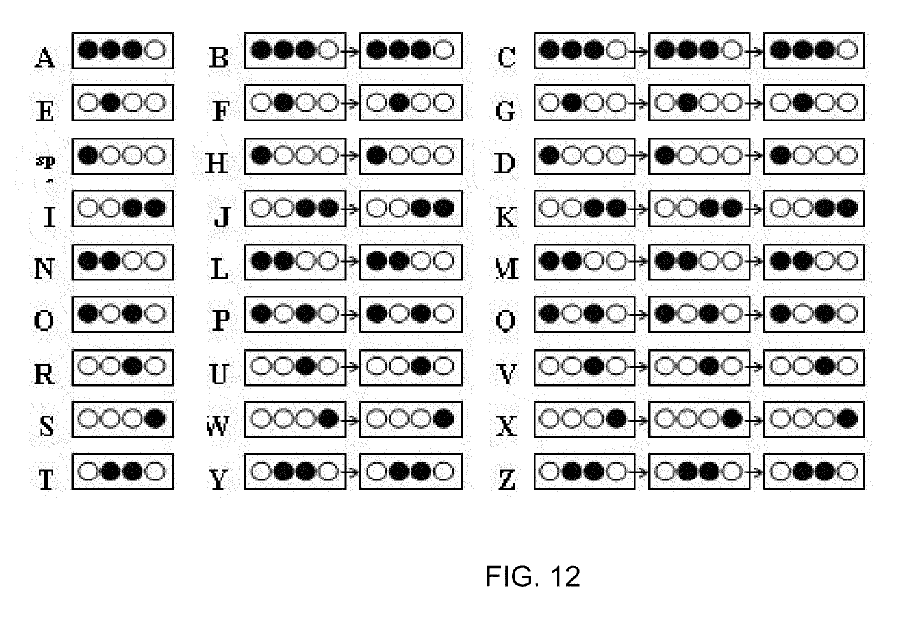

Reference is now made to FIG. 12 which illustrates how a four key input can be used to map 26 characters in a way that provides more or less alphabetical order for ease of learning but is optimized to a certain extent to reduce key press count. The key combinations along the rows, segments of the string, are the same so that characters in the second column are obtained by pressing the key combination of the first column twice, and the characters in the third column are obtained by pressing the combination three times.

Alphabetical order has been generally maintained but the most frequent characters E, T, A, O, N, R, and I, are in the first column. Note that the relatively infrequent character D has its place taken by very frequent character E in the first column and has itself been displaced to the third column.

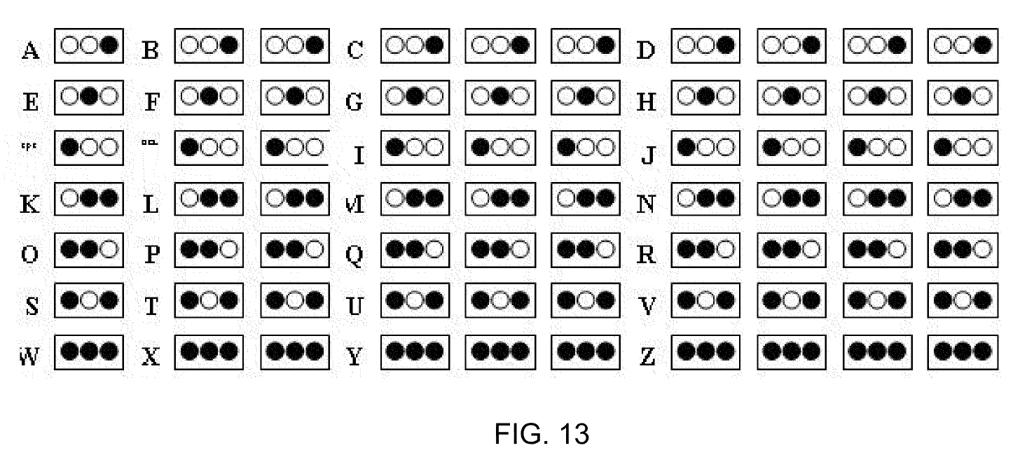

FIG. 13 shows a different mapping, again subsequent presses, segments of the string, are identical to the first. In this case the number of keys is three, and the alphabet is strictly followed. Here the relatively frequent character N requires four presses and relatively infrequent character W requires only one press.

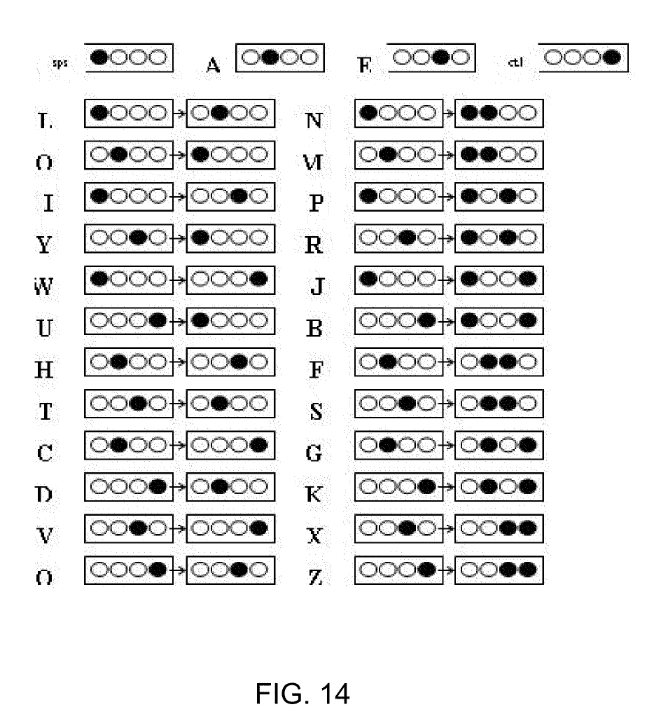

FIG. 14 is again a four key input. In this case the repeat presses or segments of the string are not the same. A and E and two reserved functions are given single segment strings, and all other characters are given two successive segments.

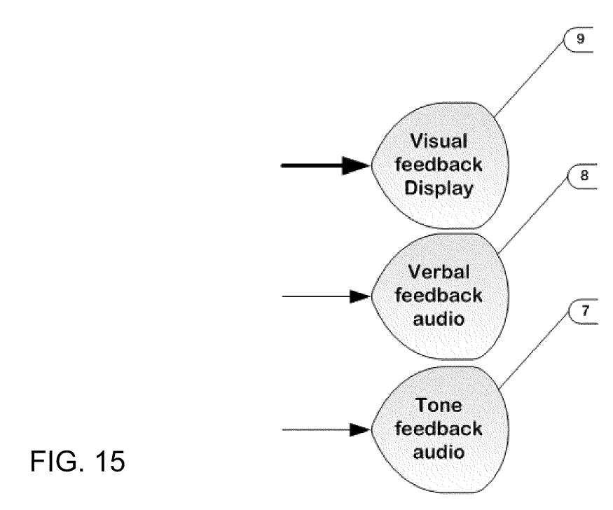

FIG. 15 illustrates three types of feedback available with a keyboard according to the present embodiments. Visual feedback is available through echo of the characters to the display. Electronic text to speech may be used for verbal feedback, and tone feedback may be used based on the keys being pressed and the resulting chord when multiple keys are pressed together.

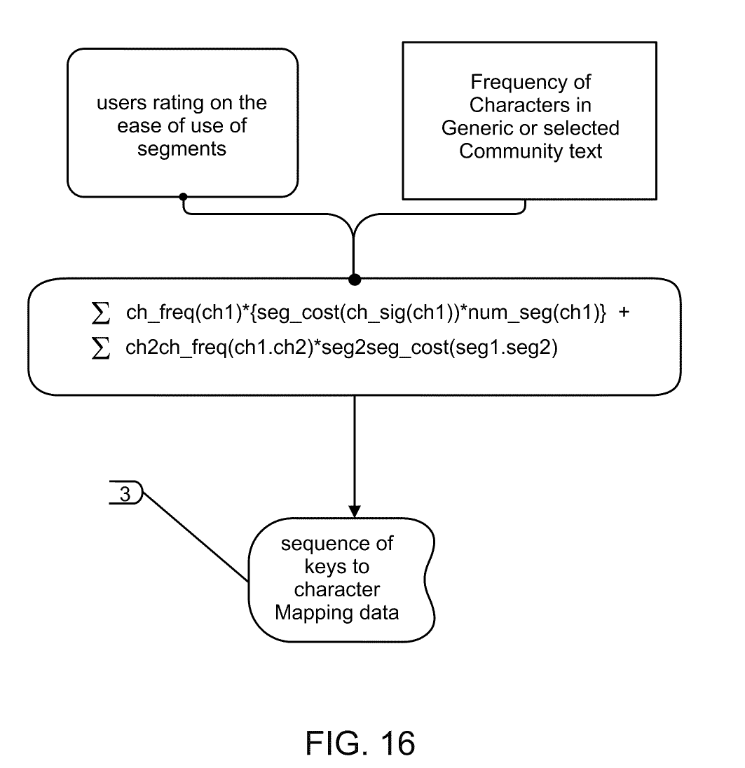

Reference is now made to FIG. 16, which illustrates the use of a cost function in carrying out a mapping of characters to form a keyboard. Users rate the ease of use of segments, as discussed above. The frequency of characters in the particular text chosen is measured. The two are combined into a cost function which measures the cost of generating text based on typical combinations of characters. The cost of a word is based on time, the cost of generating each segment of the character based on the user defined convenience multiplied by the cost of changing between segments. The whole is multiplied by the frequency of the characters. The cost of the word is then compounded from the cost of the characters by taking into account switching between the last segment of the previous character and the first segment of the next character, all multiplied by the frequency of the word.

The cost of the mapping is the summation for the entire language or database of:

Σch_freq(ch1)*{seg_cost(ch_sig(ch1))*num_seg(ch1)}+Σch2ch_freq(ch1,ch2)*seg2seg_cost(seg1,seg2)

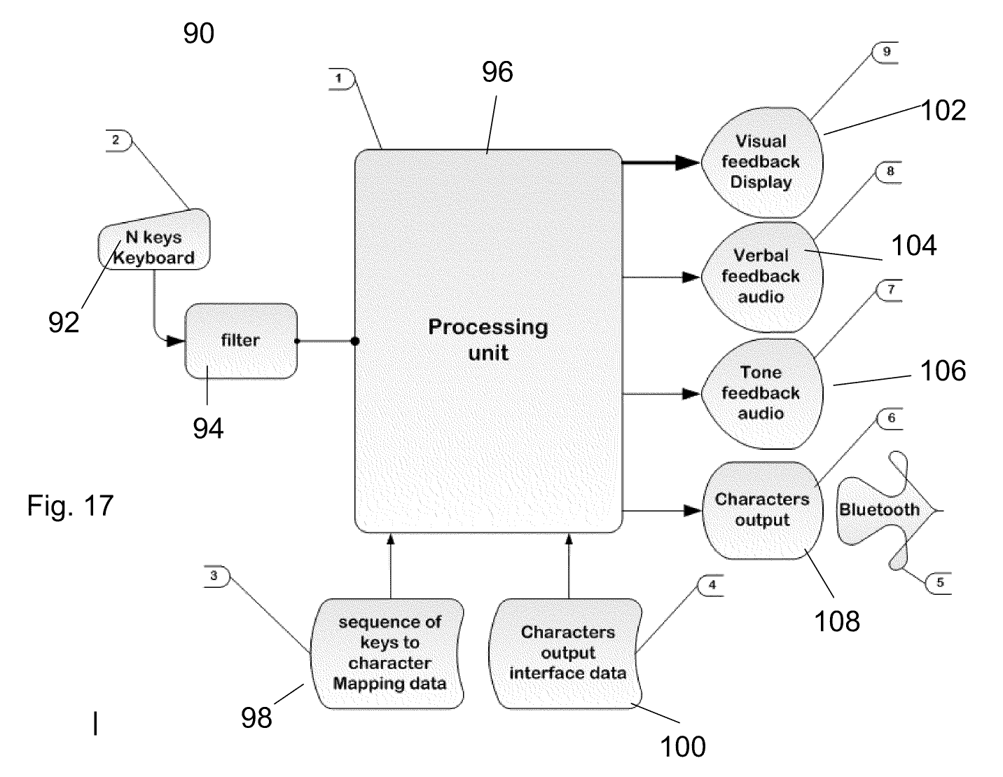

Reference is now made to FIG. 17, which is a simplified diagram illustrating a device 90 constructed according to a preferred embodiment of the present invention. The device has a keyboard 92 limited to N keys. These may be the numerical keys of a mobile telephone or like device or may be soft keys. A filter 94 filters the input from the keyboard which then goes to a processor 96. The processor adds a current segment or key combination to an input string and decides, using character mapping data 98, when a character has been input. A character output 100 echoes the character to the screen. Visual 102, verbal 104 and tone 106 output is provided as described in FIG. 15 above, and words may be output via a wireless link 108 such as a Bluetooth™ link if available.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A character input system for a limited keyboard, in which a number of input keys in the keyboard is smaller than a number of characters in an input alphabet, the system comprising:
a memory comprising a plurality of different mappings of said characters onto combinations of said keys; and
a selector for allowing a user to select one of said mappings for character input.

2. The character input system of claim 1, wherein at least one of said mappings is made for ease of learning by a user.

3. The character input system of claim 1, wherein at least one of said mappings is made to minimize key presses for typing messages in a given language.

4. The character input system of claim 1, wherein at least one of said mappings is an optimization between ease of learning by a user and a minimization of key presses for typing messages in a given language.

5. The character input system of claim 1, wherein at least one of said mappings is made to minimize repeat key operations in a given language.

6. The character input system of claim 1, wherein at least one of said mappings is made to minimize ambiguities due to similar key sequences being shared by different words.

7. The character input system of claim 2, wherein said selector is configured to allow a user to select a mapping on the basis of a preference between ease of learning, and minimization of key presses.

8. The character input system of claim 1, wherein said mapping comprises mapping of characters to combinations of said keys.

9. The character input system of claim 8, wherein at least some of said combinations are key sequences.

10. The character input system of claim 8, wherein more frequent characters in a given language are assigned to shorter combinations and less frequent characters are assigned to longer combinations.

11. The character input system of claim 8, wherein characters are assigned to combinations in the order of an alphabet of said characters.

12. The character input system of claim 8, wherein more than one character is assigned to a single combination, the user being enabled to scroll between characters sharing the same combination.

13. The character input system of claim 4, wherein said language comprises an on-line community jargon, and said optimization is based on a statistical analysis of character usage within said community.

14. The character input system of claim 8, further comprising assigning audible tones to respective keys.

15. The character input system of claim 8, further comprising displaying a selected mapping on a user screen as groups of characters, each group associated with a matrix of the keys, wherein for each matrix different keys are shown as to be activated.

16. The character input system of claim 15, wherein the mapping comprises sequential combinations of keys and each matrix shows in differentiated form, those keys to be activated earlier and those keys to be activated later in said sequential combination.

17. The character input system of claim 3, wherein said mapping to minimize key presses is constructed from a mapping having a relatively large standard deviation of the average number of presses per character, thereby to allow mapping of frequently used characters to shorter numbers of presses and less frequently used characters to longer presses.

18. A character mapping method for a limited keyboard, in which a number of input keys in the keyboard is smaller than a number of characters in an input alphabet, the method comprising:
mapping said characters in at least two different ways to keys on said keyboard, to provide at least two different keyboard mappings; and
allowing a user to select one of said keyboard mappings for character input at said limited keyboard.

19. The method of claim 18, wherein one of said mappings is provided by mapping said characters to combinations of said keys in an alphabetic order for ease of learning.

20. The method of claim 18, wherein one of said mappings is provided by:
statistically analyzing use of said characters to determine a frequency for respective characters;
providing a series of key combinations for said characters, said series having an average number of key combinations and a predetermined standard deviation from said average; and
assigning relatively frequently used characters to combinations having relatively low numbers of key presses and relatively infrequently used characters to combinations having a relatively high number of key presses, thereby to provide a mapping which minimizes key presses.

21. The method of claim 20, wherein said statistically analyzing is carried out for character usage by a defined on-line community, or wherein at least one of said mappings is made to minimize repeat key operations in a given language.

22. The method of claim 20, further comprising adding a weighting to each language based on user evaluation of a difficulty of typing respective key combinations multiplied by a frequency of occurrence of said combinations and on a difficulty in changing between different key combinations multiplied by a frequency of occurrence of said changes.

23. The method of claim 18, wherein at least one of said mappings is made to minimize ambiguities due to similar key sequences being shared by different words.

24. A method of providing a keyboard based on mapping a first number of characters onto a keyboard having a second number of keys, wherein the first number is larger than the second number, the method comprising:
analyzing a language usage database for usage statistics;
applying said characters in at least two ways onto said keyboard to form at least two mappings;
providing a score to said mapping based on said usage statistics applied to said keyboard; and
selecting between said languages for use based on said score.

25. The method of claim 24, wherein said usage statistics applied to said keyboard comprise at least one member of the group consisting of: character frequency, number of key presses needed to generate a word, number of words in the database having identical key press sequences, and number of words requiring identical key presses in succession.
